(19) United States
(12) Patent Application Publication
(10) Pub. No.: US 2025/0371618 A1
(43) Pub. Date: Dec. 4, 2025

(54) TRADING PLATFORM INTEGRATING AUTOMATED MARKET MAKER AND ORDER BOOK

(71) Applicants: Bullish Global, Cayman Islands (GB); Block.one LLC, Blacksburg, VA (US)

(72) Inventors: Daniel J. LARIMER, Allen, TX (US); Khaled Assaad AL-HASSANIEH, Blacksburg, VA (US); Maxim NAM-STORM, Hong Kong (CN); Suren Gueorgui MARKOSOV, Hong Kong (CN); Samuel HAKIM, Hong Kong (CN); Shashank Singh SOLANKI, Potong Pasir (SG); Erik Charles LEEDOM, Christiansburg, VA (US); Ian Michael Corfield SMITH, Hong Kong (CN); Justin Paul SHORT, Middlesex (GB); Dominic Joseph TOBIAS, Hong Kong (CN); Pui Son Jason MAN, Hong Kong (CN)

(21) Appl. No.: 18/998,174

(22) PCT Filed: Jul. 27, 2022
(86) PCT No.: PCT/US2022/038593

§ 371 Date: Jan. 24, 2025

(51) Int. Cl. G06Q 40/04

(52) U.S. Cl. CPC G06Q 40/045; G06Q 40/044; G06Q 40/048

(57) ABSTRACT

Embodiments relate to a trading platform with a distributed computer infrastructure. A system and method for trading digital assets that involves integrating a hybrid order book, a matching engine, an automated market manager, and safe margin lending service.

### FIELD

The improvements generally relate to the field of trading platforms, distributed computer systems, blockchain infrastructure, interfaces, and computer security.

### INTRODUCTION

New financial models have been developed for decentralized finance. A decentralized exchange can provide deterministic liquidity. A central limit order book has high performance but can fluctuate drastically. Embodiments described herein relate to an exchange or trading platform for digital assets with a new hybrid order book providing liquidity, automated market marking, and improved security. Embodiments described herein relate to an exchange platform that connects to electronic devices to receive order commands to buy, sell and trade cryptocurrencies. Embodiments described herein relate to an exchange platform for digital assets with deep, predictable liquidity across highly variable market conditions. Embodiments described herein relate to an exchange platform with improved computer security for its digital assets. Embodiments described herein relate to an exchange platform with a blockchain infrastructure integrating cryptographic and security tools.

### BACKGROUND

There exists a need for a decentralized exchange or trading platform that connects to electronic devices to receive order commands to buy, sell and trade cryptocurrencies and digital assets. There exists a need for an exchange or trading platform for digital assets with deep, predictable liquidity across highly variable market conditions. There exists a need for an exchange platform with improved computer security for its digital assets and a multi-signature custody defense. There exists a need for an improved blockchain infrastructure integrating cryptographic and security tools.

### SUMMARY

In an aspect, embodiments described herein provide systems and methods for trading assets, such as digital assets.

In an aspect, embodiments described herein provide a method for facilitating electronic trading with an electronic trading system and interfaces of electronic devices. The method involves: receiving, by at least one processor of a computing device of an electronic trading system, from an interface of an electronic device, trading commands for an order, the electronic trading system having a hybrid order book integrating liquidity provided by an automated market maker with liquidity provided by a central limit order book into a common order book; communicating the trading commands for the order within the electronic trading system using an electronic communication bus of the electronic trading system; executing the order using a matching engine and the hybrid order book integrating liquidity provided by the automated market maker with liquidity provided by the central limit order book into the common order book; after execution of the order, implementing a solvency check, using a safe margin lending service for margin lending, to determine whether another order of a maximum size does not impact solvency of margin accounts based on liquidity available from the automated market maker of the hybrid order of the electronic trading system, wherein, upon the solvency check determining that the other order of the maximum size does impact the solvency of the margin accounts, preemptively liquidating all margin accounts impacted; wherein the solvency check involves, by the safe margin lending service, determining a least collateralized position (LCP) and executing the solvency check against only the LCP; wherein the solvency check involves, by the safe margin lending service, querying the automated market maker for deterministic pricing data corresponding to a value for the one or more assets relating to the order; and updating the interface of the electronic device with status information for the order and output data of electronic trading system generated by executing the order using the matching engine, the hybrid order book, the safe margin lending service, and the automated market maker service.

In some embodiments, updating the interface comprises generating and displaying visual elements indicating the liquidity provided by the automated market maker and overall liquidity provided by the hybrid order book.

In some embodiments, the trading commands for the order indicate one or more digital assets.

In some embodiments, the order comprises a trading order price and a trading order size.

In some embodiments, the interface of the electronic device is a mobile interface, web interface, or an application programming interface.

In some embodiments, the electronic communication bus is an interprocess communication bus.

In some embodiments, the method further comprises: generating a trading event corresponding to the trading commands for the client order request using an event manager application; transmitting the trading event to the electronic communication bus of the electronic trading system.

In some embodiments, the method further comprises: routing the trading event via the electronic communication bus to an order manager application of the electronic trading system to validate the client order request; transmitting commands from the order manager application to an account manager application to process the trading event using a margin account and a liquidation engine of a safe margin lending application; and transmitting commands from the account manager application to the market manager to update a debt pool.

In an aspect, embodiments described herein provide a non-transitory machine readable medium having stored thereon a plurality of instructions that, when executed by at least one computing device, cause the at least one computing device to perform a method comprising: receiving, by at least one processor of a computing device of an electronic trading system, from an interface of an electronic device, trading commands for an order, the electronic trading system having a hybrid order book integrating liquidity provided by an automated market maker with liquidity provided by a central limit order book into a common order book; communicating the trading commands for the order within the electronic trading system using an electronic communication bus of the electronic trading system; executing the order using a matching engine and the hybrid order book integrating liquidity provided by the automated market maker with liquidity provided by the central limit order book into the common order book; after execution of the order, implementing a solvency check, using a safe margin lending service for margin lending, to determine whether another order of a maximum size does not impact solvency of margin accounts based on liquidity available from the automated market maker of the hybrid order of the electronic trading system, wherein, upon the solvency check determining that the other order of the maximum size does impact the solvency of the margin accounts, preemptively liquidating all margin accounts impacted; wherein the solvency check involves, by the safe margin lending service, determining a LCP and executing the solvency check against only the LCP; and wherein the solvency check involves, by the safe margin lending service, querying the automated market maker for deterministic pricing data corresponding to a value for the one or more assets relating to the order.

In some embodiments, the non-transitory machine readable medium performs the method further comprising: updating the interface of the electronic device with status information for the order and output data of electronic trading system generated by executing the order using the matching engine, the hybrid order book, the safe margin lending service, and the automated market maker service.

In some embodiments, updating the interface comprises generating and displaying visual elements indicating the liquidity provided by the automated market maker and overall liquidity provided by the hybrid order book.

In some embodiments, the trading commands for the order indicate one or more digital assets.

In some embodiments, the order comprises a trading order price and a trading order size.

In some embodiments, the interface of the electronic device is a mobile interface, web interface, or an application programming interface.

In an aspect, embodiments described herein provide an apparatus comprising: at least one processor; and a memory that stores instructions which, when executed by the at least one processor, directs the at least one processor to: receive, by at least one processor of a computing device of an electronic trading system, from an interface of an electronic device, trading commands for an order, the electronic trading system having a hybrid order book integrating liquidity provided by an automated market maker with liquidity provided by a central limit order book into a common order book; communicate the trading commands for the order within the electronic trading system using an electronic communication bus of the electronic trading system; execute the order using a matching engine and the hybrid order book integrating liquidity provided by the automated market maker with liquidity provided by the central limit order book into the common order book; after execution of the order, implement a solvency check, using a safe margin lending service for margin lending, to determine whether another order of a maximum size does not impact solvency of margin accounts based on liquidity available from the automated market maker of the hybrid order of the electronic trading system, wherein, upon the solvency check determining that the other order of the maximum size does impact the solvency of the margin accounts, preemptively liquidating all margin accounts impacted; wherein the solvency check involves, by the safe margin lending service, determining a LCP and executing the solvency check against only the LCP; wherein the solvency check involves, by the safe margin lending service, querying the automated market maker for deterministic pricing data corresponding to a value for the one or more assets relating to the order; and update the interface of the electronic device with status information for the order and output data of electronic trading system generated by executing the order using the matching engine, the hybrid order book, the safe margin lending service, and the automated market maker service.

In some embodiments, the processor updates the interface by generating and displaying visual elements indicating the liquidity provided by the automated market maker and overall liquidity provided by the hybrid order book.

In some embodiments, the trading commands for the order indicate one or more digital assets.

In some embodiments, the order comprises a trading order price and a trading order size.

In some embodiments, the interface of the electronic device is a mobile interface, web interface, or an application programming interface.

In an aspect, embodiments described herein provide an electronic trading system comprising: at least one processor of a computing device of an electronic trading system that receives, from an interface of an electronic device, trading commands for an order, the electronic trading system having a hybrid order book integrating liquidity provided by an automated market maker with liquidity provided by a central limit order book into a common order book; an electronic communication bus of the electronic trading system that communicates the trading commands for the order within the electronic trading system; a matching engine that executes the order using the hybrid order book integrating liquidity provided by the automated market maker with liquidity provided by the central limit order book into the common order book; a safe margin lending service for margin lending, that, after execution of the order, implements a solvency check, using, to determine whether another order of a maximum size does not impact solvency of margin accounts based on liquidity available from the automated market maker of the hybrid order of the electronic trading system, wherein, upon the solvency check determining that the other order of the maximum size does impact the solvency of the margin accounts, preemptively liquidating all margin accounts impacted; wherein the safe margin lending service implements the solvency check by determining a LCP and executing the solvency check against only the LCP; wherein the safe margin lending service implements the solvency check by querying the automated market maker for deterministic pricing data corresponding to a value for the one or more assets relating to the order.

In some embodiments, the system has an interface of an electronic device that automatically updates with status information for the order and output data of electronic trading system generated by executing the order using the matching engine, the hybrid order book, the safe margin lending service, and the automated market maker service.

In some embodiments, the interface comprises visual elements indicating the liquidity provided by the automated market maker and overall liquidity provided by the hybrid order book.

In some embodiments, the trading commands for the order indicate one or more digital assets.

In some embodiments, the order comprises a trading order price and a trading order size.

In some embodiments, the interface of the electronic device is a mobile interface, web interface, or an application programming interface.

In some embodiments, the electronic communication bus is an interprocess communication bus.

In an aspect, embodiments described herein provide a system for trading digital assets. The system involves an event manager for placing client orders for trading digital assets and transmitting commands to an order manager; a matching engine to receive the order from the order manager, wherein the matching engine posts inline actions to market events for the order; a market manager that transits commands to the order manager to update reserves, wherein the market manager sends commands to the matching engine to add interest to order book reserves; an order manager that transits commands to the account manager to update on trades, new orders, and closed orders; wherein the market manager and a liquidation engine exchange messages for solvency checks and pre-liquidation data to update the debt pool for a total withdrawal amount.

In another aspect, embodiments described herein provide a method for trading digital assets. The method involves: placing client orders and transmitting commands to an order manager; receiving order events at a matching engine from the order manager; posting inline action to market events for the order using the matching engine; transmitting commands to a market manager to update reserves and send commands to the matching engine; transmitting commands to an account manager to update trades, new orders, and closed orders; transmitting messages to the liquidation engine for solvency checks and pre-liquidation data to update the debt pool for a total withdrawal amount.

Many further features and combinations thereof concerning embodiments described herein will appear to those skilled in the art following a reading of the instant disclosure.

### DESCRIPTION OF THE FIGURES

In the figures,

FIGS. 1A, 1B, 1C, 1D, 1E, and 1F show an example trading platform.

FIG. 2 shows an example system for an exchange platform with a hybrid order book.

FIGS. 3A, 3B, 3C show an example trading platform.

FIG. 4 shows an example trading platform.

FIG. 5 shows example code for a manager account of a trading platform.

FIG. 6 shows example code for an account transfer of a trading platform.

FIG. 7 shows example code for an event manager of a trading platform.

FIGS. 8A, 8B show example code for a liquidation engine of a trading platform.

FIGS. 9A, 9B show example code for a liquidation engine of a trading platform.

FIGS. 10A, 10B show example code for a trading platform.

FIG. 11 shows an example process for a trading platform.

FIG. 12 shows an example electronic device for a trading platform.

FIG. 13 shows an example user interface for a trading platform.

### DETAILED DESCRIPTION

Embodiments described herein provide systems and methods for an exchange or trading platform.

Embodiments described herein relate to an exchange or trading platform for digital assets with liquidity, automated market marking, and improved security. Embodiments described herein relate to an exchange platform that connects to electronic devices to buy, sell and trade cryptocurrencies. Embodiments described herein relate to an exchange platform for digital assets with deep, predictable liquidity across highly variable market conditions.

Embodiments described herein relate to an exchange platform that provides a new hybrid order book integrating an automated market maker with a central limit order book. The hybrid order book combines the high-performance of a central limit order book (CLOB) with deep, deterministic liquidity across market conditions from automated market making (AMM). Embodiments described herein relate to an exchange platform with a liquidity pool for AMM and safe margin lending.

The trading platform involves a hybrid order book. The trading platform provides a hybrid order book that aggregates central limit order book and an automated market maker (AMM). The hybrid order book involves a matching engine. The trading platform integrates the AMM and matching engine to merge efficiently in a multi tiered environment.

An AMM can be a software and hardware component used for decentralized exchange. An AMM can use a formula to calculate the rate or price, and does not use an central limit order book (ask and bid orders) for the rate or price as used for a traditional exchange. Cryptocurrencies are priced according to a pricing process calculated using the formula.

A matching engine can be a software and hardware component of an electronic exchange. A matching engine can match up bids and offers to complete trades. Matching engines can allocate trades among competing bids and offers. An example matching engine can be implemented by Cordis. This is a non-limiting example. A matching engine can involve a function that takes an order and an order book as input parameters, and returns a list of trades plus all the remaining orders. The remaining orders can be used for the order book for the next order received by the matching engine. The Appendix attached herein shows example operations for Cordis which can be used to implement aspects of the matching engine, and other components of system.

The trading platform involves safe margin lending which is a process for deterministic margin/model lending. The trading platform implements margin lending using a liquidity pool. The trading platform presents multiple pools as a single source of liquidity extending to the multiple pools. The trading platform uses a method to determine how much liquidity is provided by the hybrid order book (e.g. the AMM and the central limit order book). The trading platform uses a pricing process (e.g. algorithm/formula) to determine liquidity at different price levels.

The trading platform involves price dislocation fees and processes to determine dislocation spread and calculations based on a curve function.

The trading platform provides a client interface to access functionality of the hybrid order book. The interface also provides improved visualizations of trading data from the trading platform and provide improved selectable indicia to send commands to the trading platform. The trading platform involves improved memory organization and price determination.

Embodiments described herein relate to an exchange platform with improved computer security for its digital assets and a multi-signature custody defense. Embodiments described herein relate to an exchange platform with a block chain infrastructure integrating cryptographic and security tools.

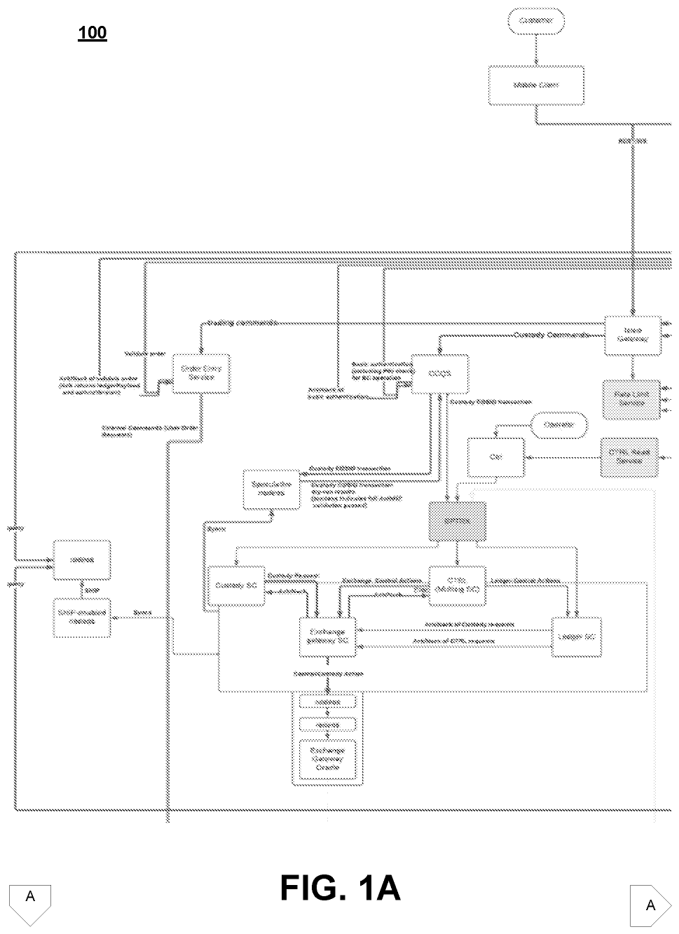

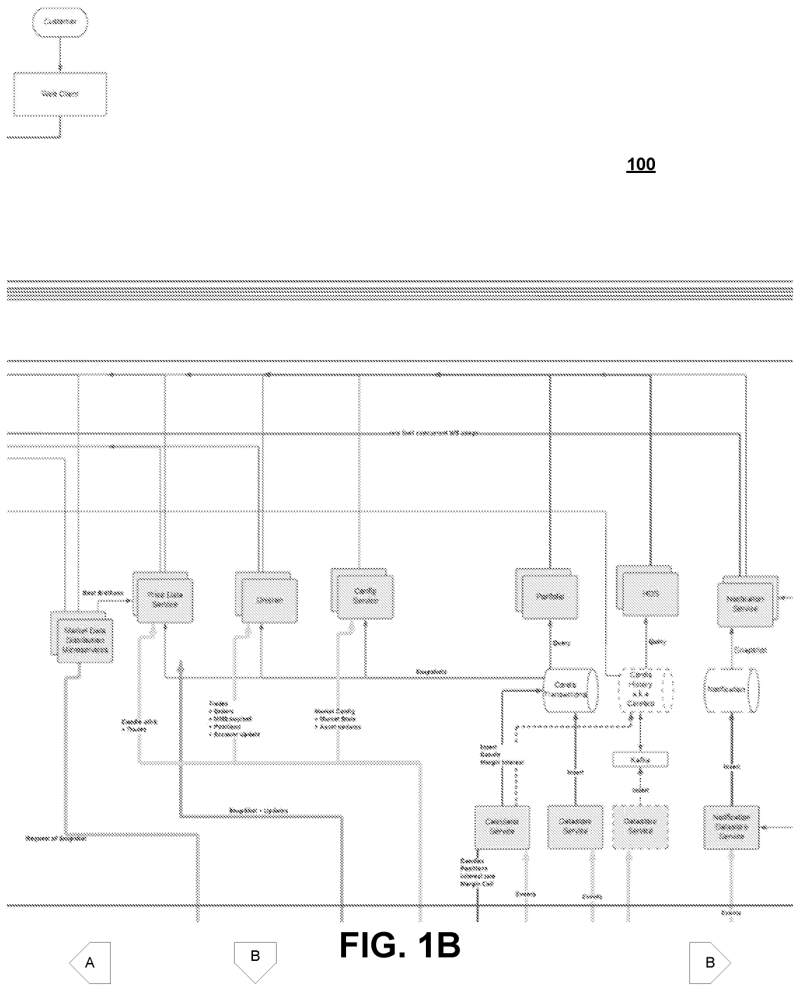

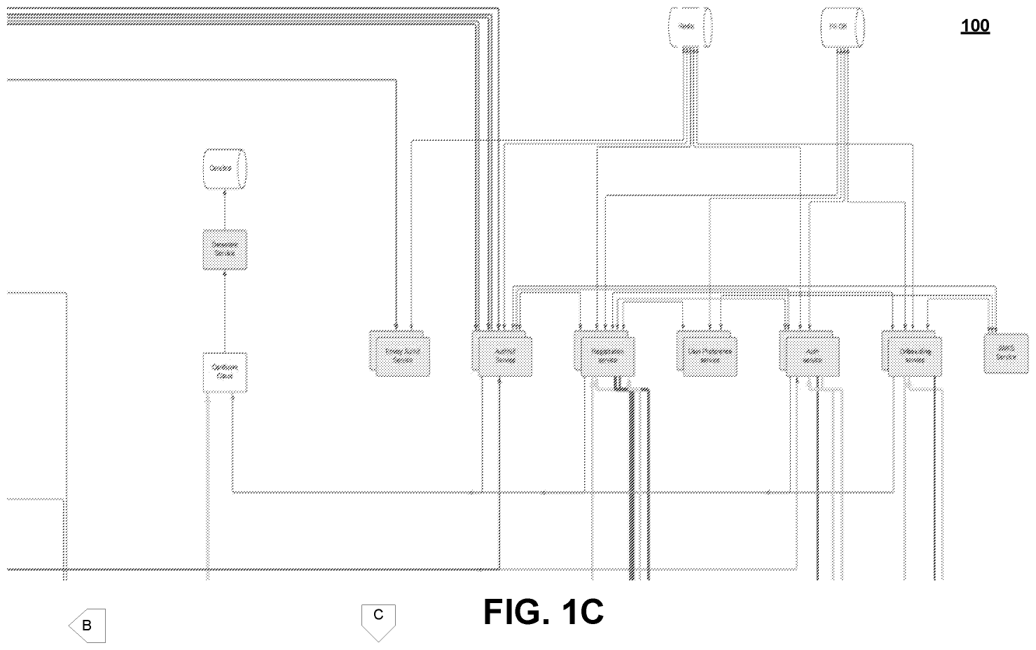

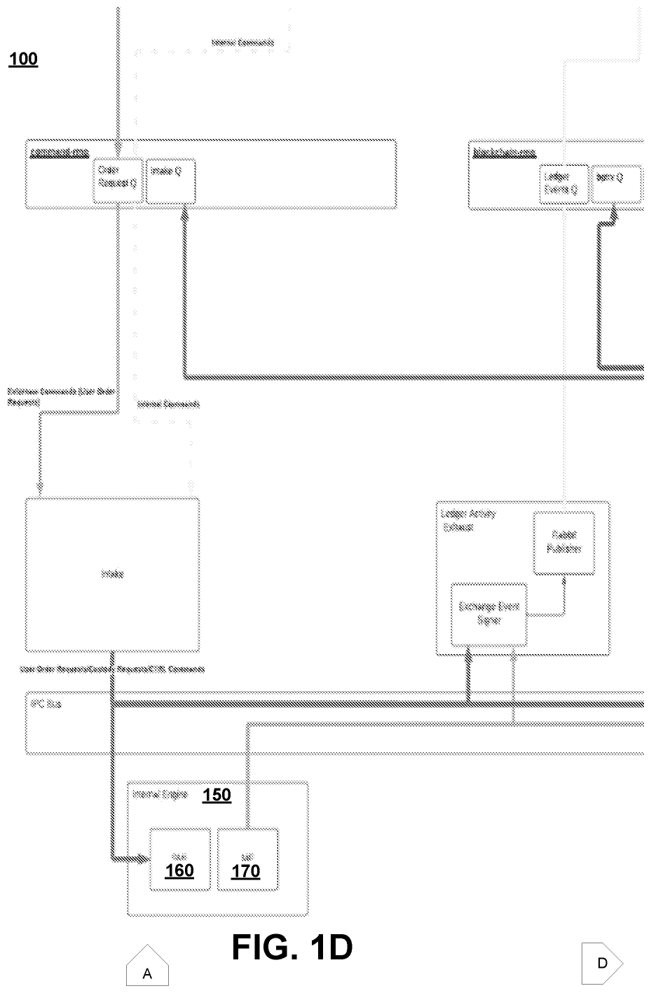

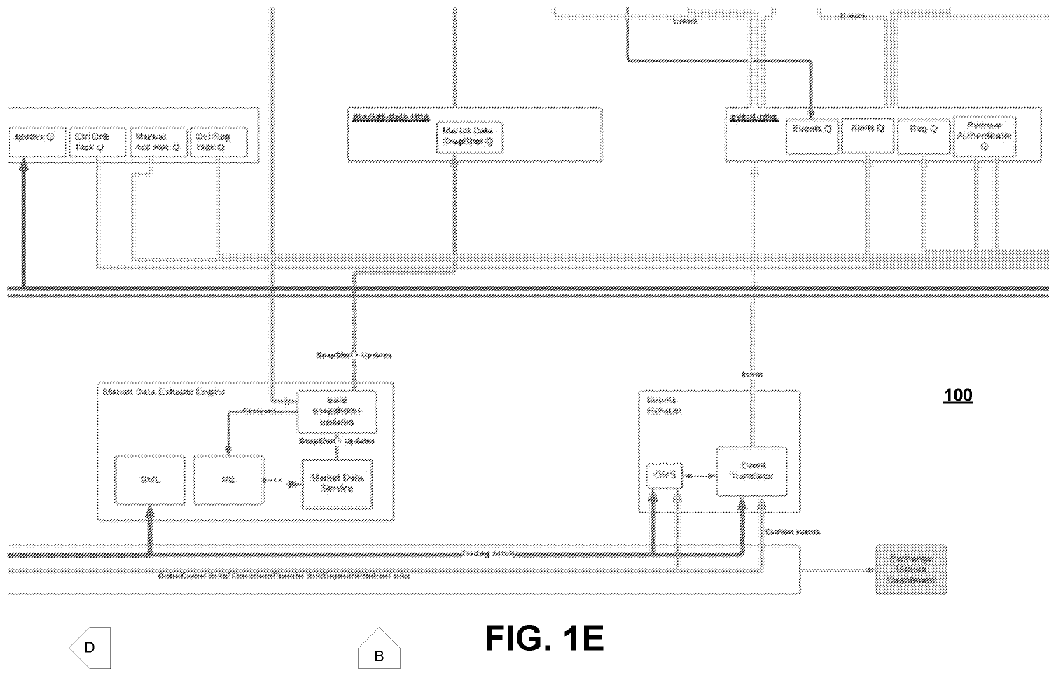

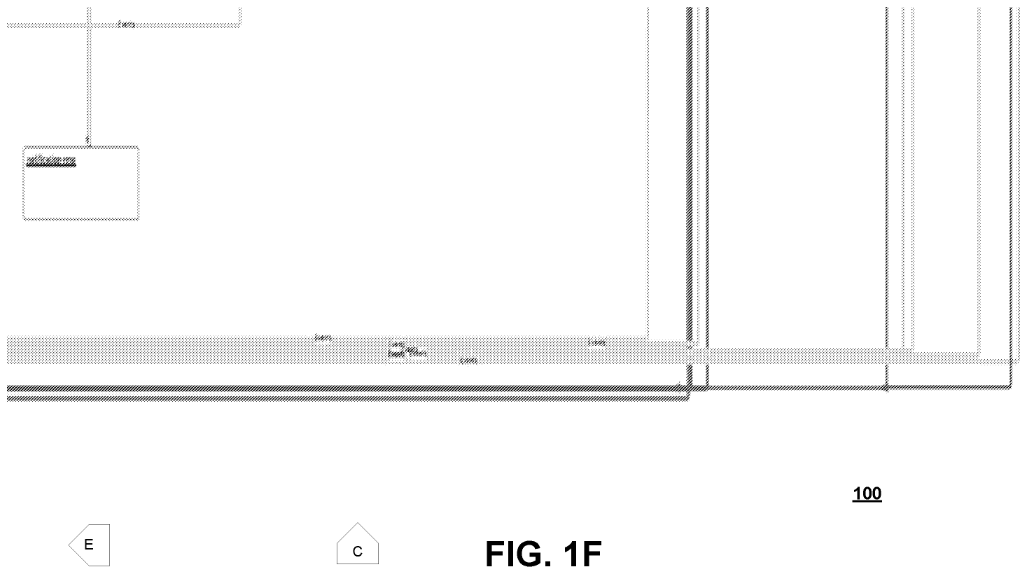

FIGS. 1A, 1B, 1C, 1D, 1E, and 1F show example schematic diagrams of a system 100 for a trading platform. The system has an event manager for placing client orders for trading digital assets and transmitting commands to an order manager. The system has a matching engine to receive the order from the order manager. The matching engine posts inline actions to market events for the order. The system has a market manager that transits commands to the order manager to update reserves, wherein the market manager sends commands to the matching engine to add interest to order book reserves. The system has an order manager that transits commands to the account manager to update on trades, new orders, and closed orders. The market manager and a liquidation engine exchange messages for solvency checks and pre-liquidation data to update the debt pool for a total withdrawal amount.

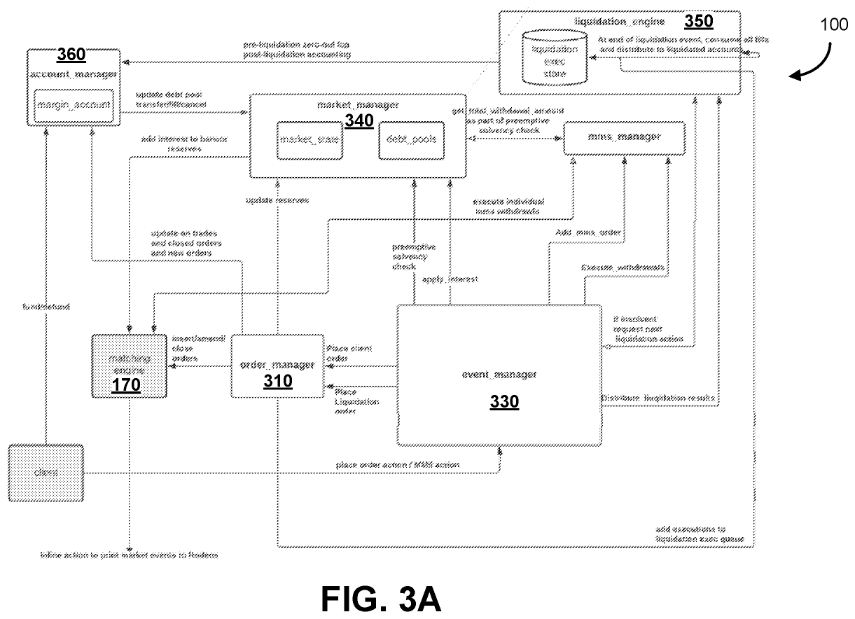

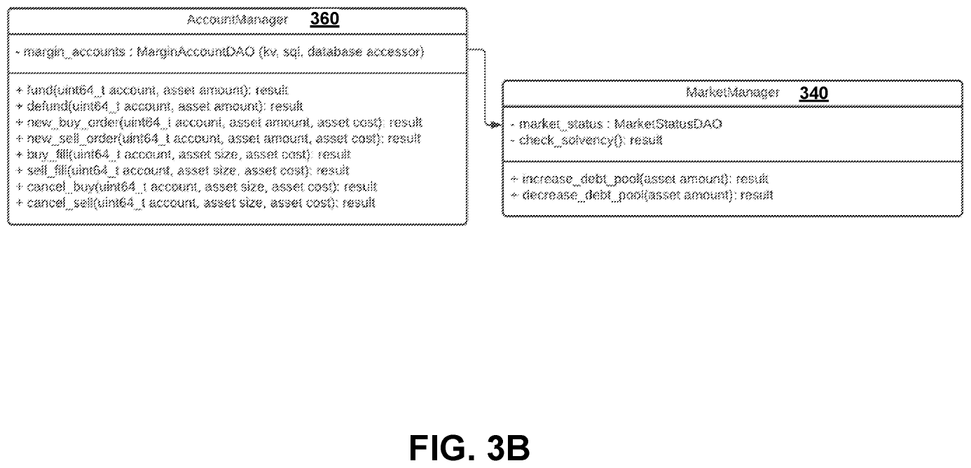

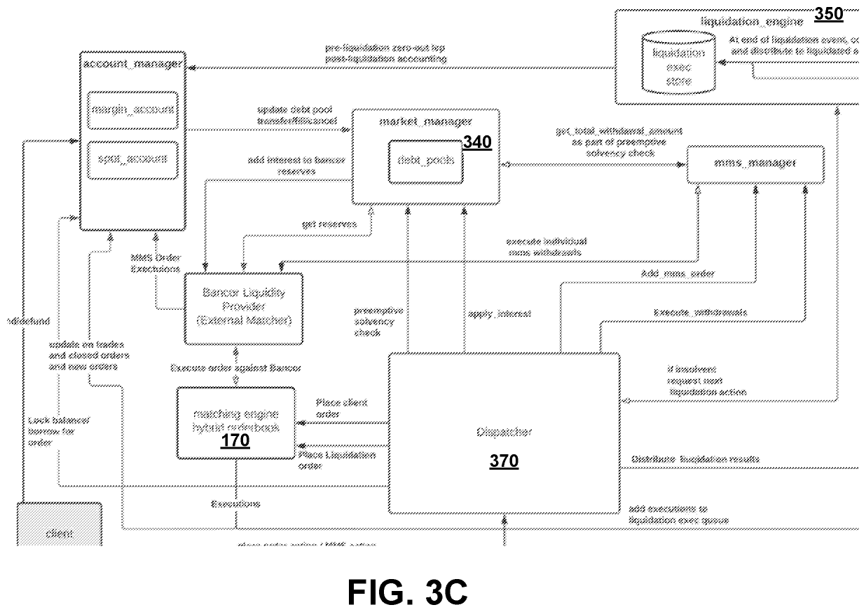

FIGS. 1A, 1B, 1C, 1D, 1E, and 1F show example client commands, providing status of those commands, and market data. FIG. 1D shows an internal engine 150 with safe margin lending 160 and a matching engine 170, with further details provided in relation to FIGS. 3A and 3B.

As shown in FIG. 1A, the system 100 has a mobile client to receive buy, sell or trade order or request, which can be referred to as trading comments. A gateway receives the trading commands from the client and routes the trading comments to an order entry service to validate the trading command or order.

The gateway can also receive custody commands. The gateway can route custody commands for authentication. The system transmits custody transactions to speculative nodeos which is a node service for blockchain infrastructure that can be used for as a storage protocol for the system 100 across distributed memory devices. The BPTRX can also receive messages and commands from the control (CTRL) read service.

The BPTRX transmits the custody transactions to custody smart contract (SC) which transmits custody requests to an exchange gateway SC.

The BPTRX transmits the custody transactions to a CTRL component which can be a multiple signature SC. The CTRL component implements actions for the exchange to make changes to the system, such as changing configuration parameters, for example. The multiple signature SC can govern changes such that when an entity proposes a change and then other entities have to validate or approve the change with signatures before it is implemented.

An exchange gateway SC exchanges control actions with the CTRL multiple signature SC and custody requests with custody SC. The exchange gateway SC also exchanges custody requests and CTRL requests with ledger SC. The exchange gateway SC transmits custody and control actions to nodeos, rodeos, and an exchange gateway oracle.

The system 100 also has a rate limit service that rates orders or requests.

The system 100 also has rodeos and nodeos that exchange queries from an authentication service (shown in FIG. 1C). The nodeos is a component for the blockchain storage infrastructure for the system 100. The nodeos services manages nodes of the blockchain. The rodeos service queries the blockchain such that the queries are read only requests for data managed and stored by the blockchain.

As shown in FIG. 1B, the system 100 has market data distribution microservices that transmit best bid/ask messages to a price data service for trades. The system 100 also has unicron service for trades, orders, market maker share (MMS) buy or sell orders, positions, and account updates. For an MMS order a user can buy or sell MMS (shares). The use can deposit liquidity in the AMM and in return receive shares (MMS). The system 100 has a configuration service for market configurations for market states and asset updates. The system 100 has a portfolio service that receives queries and events from a matching engine (e.g. Cordis) transactions database, a datastore service, and a calculator service about interest and margin calls. The system 100 has Historical Data Service (HDS) that receives queries and events from a (Cordis) history database and datastore service. The system 100 has a notification service that receives queries and events from a notification datastore service.

As shown in FIG. 1C, the system 100 provides authentication and security tools. The system 100 has a confluent cloud service and datastore service. The system 100 has authentication services. The system 100 has a registration service, user preference service, onboarding service, and a service that can authenticate tokens that identify sessions.

As shown in FIG. 1D, the system 100 has an internal engine with safe margin lending (SML) 160 and a matching engine (ME) 170. The ME 170 can include an AMM. The internal engine 150 integrates the AMM of the ME 170 with liquidity of the SML 160. The internal engine 150 executes orders against the AMM using a hybrid order book. The system 100 provides a hybrid order book with SML 160 and ME 170 (with AMM). Further details of components of SML 160 and ME 170 are provided in relation to FIGS. 3A and 3B.

The system 100 has Order Entry Service (shown in FIG. 1A) that transmits commands or order requests to command-rmg (with order request and intake components) which routes the commands to an intake service and an interprocess communication (IPC) bus. The internal engine 150 transmits commands to a Ledger Activity Exhaust service and Blockchain service.

As shown in FIG. 1E, the system 100 has a Market Data Exhaust Engine that transmits snap shots and updates to a Market-data-rgm service. The system 100 has an Events Exhaust Engine that transmits or routes events to an Event-rmg service. The system 100 has an Exchange Metrics Dashboard to exchange data with an interface.

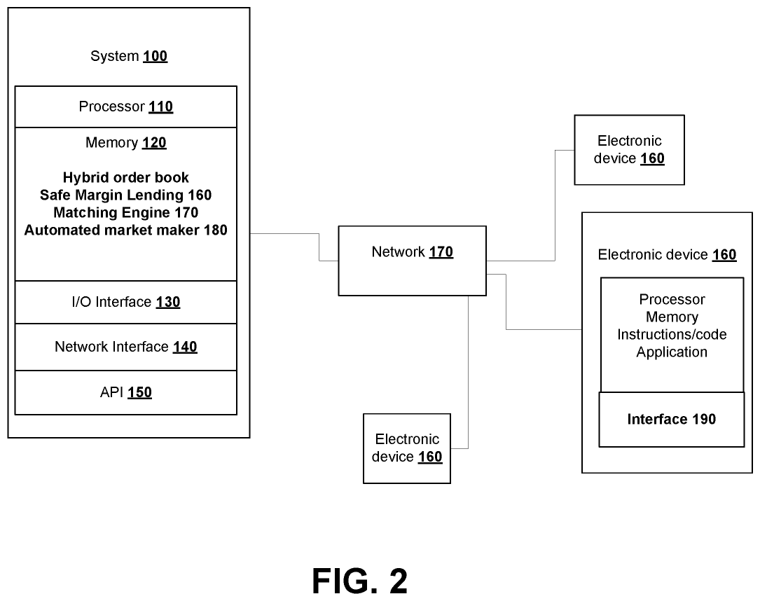

FIG. 2 shows another example schematic diagram of a system 100 for an trading platform. The system 100 includes at least one processor 110, memory 120, at least one I/O interface 130, at least one network interface 140, and an application programming interface (API) 150. The I/O interface 130 enables system 100 to interconnect with one or more input devices, such as a keyboard, mouse, camera, touch screen and a microphone, or with one or more output devices such as a display screen and a speaker. The network interface 140 enables system 100 to communicate with other components, to exchange data with other components, to access and connect to network resources, to serve applications, and perform other computing applications by connecting to a network 170 (or multiple networks, or a combination of different networks) capable of carrying data. The hardware components of system 100 may be connected in various ways including directly coupled, indirectly coupled via a network, and distributed over a wide geographic area and connected via a network (which may be referred to as “cloud computing”). For example, and without limitation, the system 100 may be a server, network appliance, embedded device, computer expansion module, or other computing device capable of being configured to carry out the methods described herein. Memory 120 can be distributed storage devices for a blockchain infrastructure.

The system 100 is an electronic trading system that manages a trading exchange for digital assets. The system 100 has a hybrid order book with SML 160, ME 170, and an AMM 180. System 100 has distributed memory to provide blockchain infrastructure.

The SML 160 provides for deterministic margin/model lending by obtaining deterministic pricing from AMM 180. The SML 160 provides margin lending for orders. The SML 160 can implement margin lending using a liquidity pool. The SML 160 presents multiple pools as a single source of liquidity extending to the multiple pools. The SML 160 uses AMM 180 to determine how much liquidity is provided by the hybrid order book (e.g. AMM 180 integrated with a central limit order book). The SML 160 uses AMM 180 for pricing digital assets relating to the order to determine when one or more margin accounts are solvent. The SML 160 implements a solvency check for orders received by system 100. The SML 160 uses AMM 180 for its pricing process (e.g. algorithm/formula) to determine liquidity at different price levels. AMM 180 integrates with a central limit order book. AMM 180 also implements a dislocation spread, as described herein. The SML 160 queries AMM 180 and checks its debt pool (which is part of SML 160).

The ME 170 provides a closed limit order book. The ME 170 executes orders by checking with the AMM 180 to see if the system 100 has liquidity, and its closed limit order book. The ME 170 executes multiple orders and multiple price levels against its order book and also checks with the SML 160 (and the AMM 180) at each price level to see if the system 100 can contribute to the order (via margin lending, for example). The ME 170 iterates through all the orders to see if the AMM 180 can offer additional liquidity.

The system 100 connects to one or more electronic devices 160 to exchange data. An electronic device 160 can have memory storing instructions for applications and one or more processors that execute the instructions and applications. The memory can store instructions for an interface 190 to exchange data with the system 100. For example, an electronic device 160 can transmit orders, requests, or commands to system 100, such as buy, sell, or trade orders. The electronic device 160 has an interface to receive trading commands for an order to provision to the system 100.

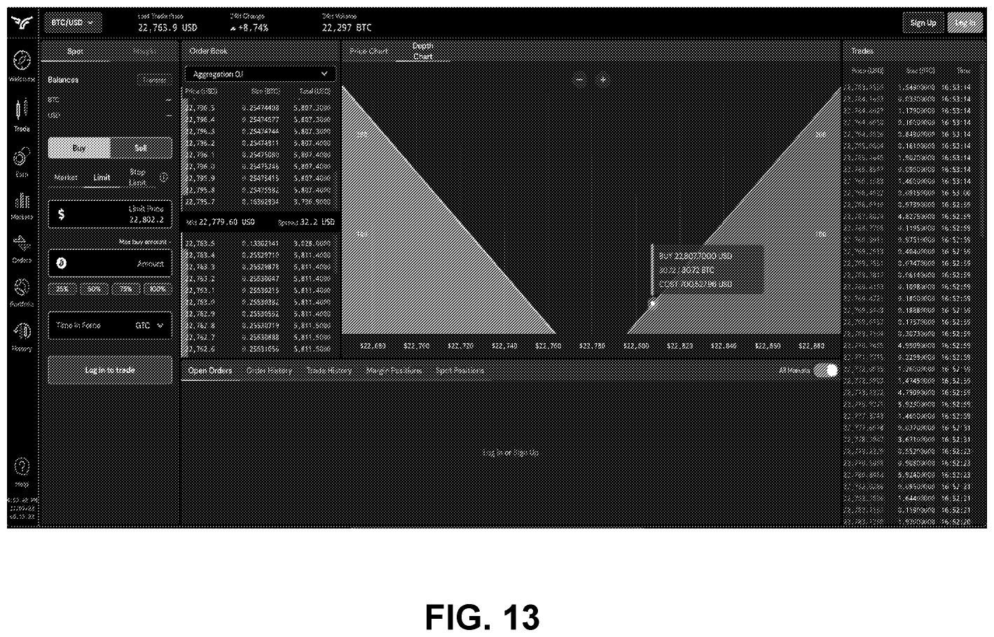

The electronic device 160 has an interface to provide visualizations of data received from system 100. FIG. 13 shows an example user interface for a trading platform. The example interface includes a depth chart visualization. The example interface is visualizations corresponding to liquidity provided by the AMM. For example, the depth chart visualization displays values between BUY and COST that indicate the liquidity provided by the AMM. Within the hybrid order book bids/offers can come from both users placing resting limit orders and the AMM itself. The values shown will reflect the liquidity provided by the AMM and the liquidity provided in total at the price point highlighted ($22,807.7 in this case).

The electronic trading system 100 has at least one processor 100 of a computing device that receives, from an interface 190 of an electronic device 160, trading commands for an order. The electronic trading system 100 has a hybrid order book integrating liquidity provided by an AMM 180 with liquidity provided by a central limit order book into a common order book. The system 100 has an electronic communication bus that communicates the trading commands for the order within the electronic trading system. The system 100 has a ME 170 that executes the order using the hybrid order book integrating liquidity provided by the AMM 180 with liquidity provided by the central limit order book into the common order book. The system 100 has an SML 160 service for margin lending, that, after execution of the order, implements a solvency check to determine whether another order of a maximum size does not impact solvency of margin accounts based on liquidity available from the automated market maker of the hybrid order of the electronic trading system. Upon the solvency check determining that the other order of the maximum size does impact the solvency of the margin accounts, the SML 160 preemptively liquidates all margin accounts impacted. The SML 160 can implement the solvency check by determining a LCP and executing the solvency check against only the LCP. The SML 160 implements the solvency check by querying the AMM 180 for deterministic pricing data corresponding to a value for the one or more assets relating to the order. In some embodiments, the trading commands for the order indicate one or more digital assets, such as cryptocurrency. In some embodiments, the order comprises a trading order price and a trading order size. In some embodiments, the electronic communication bus is an interprocess communication bus.

In some embodiments, the system 100 connects to an interface 190 of an electronic device 160 that automatically updates with status information for the order and output data of electronic trading system 100 generated by executing the order using the ME 170, the hybrid order book, the SML 160, and the AMM 180 service. In some embodiments, the interface 190 of the electronic device 160 is a mobile interface, web interface, or an application programming interface (API).

In some embodiments, the interface 190 comprises visual elements indicating the liquidity provided by the automated market maker and overall liquidity provided by the hybrid order book. See FIG. 13 as an example interface.

FIG. 3A shows example components of an example system 100 with a ME 170, order manager 310, event manager 330, market manager 340, liquidation engine 350, and account manager 360.

An account manager 360 can receive a deposit request from client interface and can update the debt pool in the market manager 340. The order manager 310 executes trades for the market manager 340. The order manager 310 can receive a margin order from client, and can send a request to account manager 360 to update the margin account balances and debt pool. If the operation fails then the system 100 can return a failure error (e.g. insufficient collateral, debt pool full). If the operation succeeds then the system 100 creates a new order record and submits the order to the ME 170. The order manager 310 receives the trades, and sends a list of trade accounts to the account manager 360. The account manager 360 updates its account and the market state. The system 100 can also match the order against the order book (e.g. Bancor) and update the reserves on the market state.

FIG. 3B shows an example class diagram of functions or processes for account manager 360 and market manager 340.

FIG. 3C shows another example system 100 with a dispatcher 370, ME 170, market manager 340, liquidation engine 350, and account manager. The dispatcher 370 dispatches events relating to orders received by the system 100.

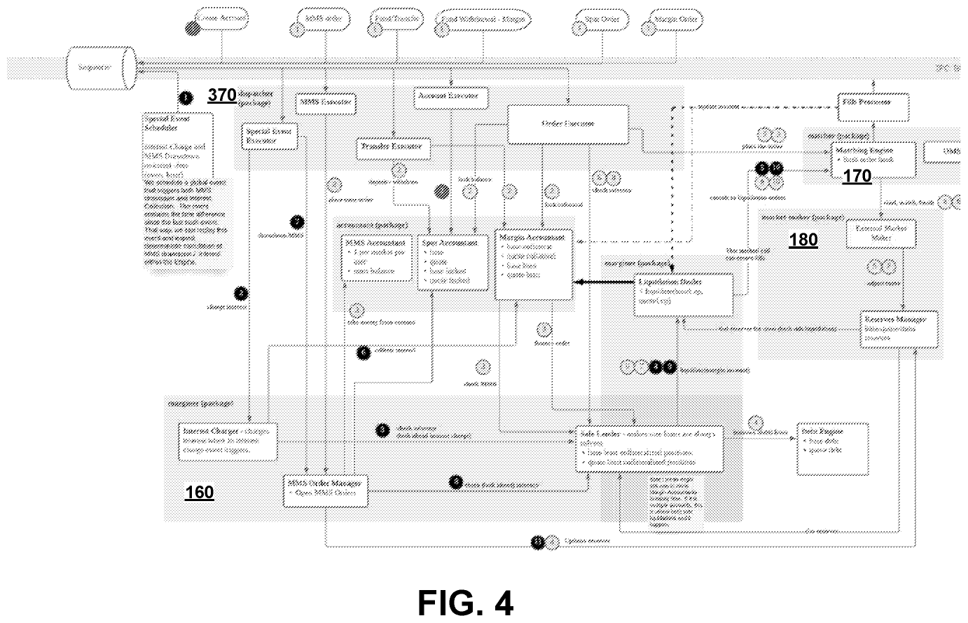

FIG. 4 shows another example system 100 for an electronic trading exchange with SML 160, ME 170, and an AMM 180. The system 100 also has a dispatcher 370, or event manager, which dispatches events. The system 100 can handle different types of orders or requests such as an account creation order, MMS order, fund or transfer order, fund withdrawal order, spot order, and margin order. Orders are generally similar and are routed to ME 170, except for MMS orders. An MMS order is a contribution to AMM 180. An order relates to one or more digital assets.

For example, an order can relate to trading one asset for another asset. The system 100 executes an order by using both the AMM 180 and the limit order book (of the hybrid order book).

The ME 170 is a component of system 100 which is an electronic exchange platform to executes orders. The ME 170 iterate through multiple orders to match up bids and offers to complete trades. The ME 170 can allocate trades among competing bids and offers. An example matching engine can be implemented by Cordis with example operations provided in the Appendix attached hereto. The ME 170 queries the SML 160 to execute orders. The SML 160 obtains deterministic pricing data from AMM 180 for the order. The AMM 180 integrated with a normal limit order book to provide a hybrid order book that can resolve orders using both a liquidity pool and orders of the order book. The SML 160 checks with the AMM 180 and its debt pool (e.g. a debt pool is part of the SML 160). The AMM 180 can also implement a dislocation spread. The SML 160 implements margin trading to lend out for the order and uses the AMM 180 to price the assets so that the SML 160 knows its margin accounts are solvent. The SML 160 implements a solvency check on its reserves and debt pool. The ME 170 can use a closed limit order book so that as the ME 170 executes an order it checks with the AMM 180 to see if it has liquidity. The ME 170 executes against multiple orders and multiple price levels. The ME 170 checks with the AMM 180 at each level to see if it can contribute to the order. The ME 170 iterates through all the orders to see if the AMM 180 can offer additional liquidity. The ME 170 can check the AMM 180 and then its order book to execute orders. The ME 170 signal the AMM 180 and SML 160 as the ME 170 iterates through the orders.

The dispatcher 370 can receive an MMS order and can generate an order event. The dispatcher can route the event for the MMS order to the SML 160. The SML 160 queries an accountant (e.g. account manager service) to take money from an account for the order. The SML 160 the AMM 180 to update reserves and adjust the curve. The dispatcher 370 can receive different types of orders (e.g. transfer order, fund withdrawal order, spot order, and margin order) and can generate order events.

The SML 160 can implement solvency checks based on a least collateralized position (LCP) to make sure margin loans are solvent. The SML 160 can borrow from a debt pool for margin lending.

The dispatcher 370 receives trading commands for orders. The system 100 has a hybrid order book integrating liquidity provided by the AMM 180 with liquidity provided by a central limit order book into a common order book. The trading commands for the order indicate one or more digital assets, such as cryptocurrency assets. The orders can also indicate different types of assets, and digital assets are an example embodiments.

The dispatcher 370 communicates the trading commands for the order within the electronic trading system 100 (e.g. using an electronic communication bus of the electronic trading system). The ME 170 can execute the order using the hybrid order book integrating liquidity provided by the AMM 180 with liquidity provided by the central limit order book integrated into the common order book.

After execution of the order, the SML 160 monitors solvency by determining whether another order of a maximum size does not impact solvency of margin accounts based on liquidity available from the AMM 180 of the hybrid order. If the monitoring determines that the other order of the maximum size does impact the solvency of the margin accounts then, the SML 160 can preemptively liquidating all margin accounts impacted.

The solvency check by the SML 160 can involve determining a LCP and executing the solvency check against only the LCP. The solvency check by the SML 160 can involve querying the AMM 180 for deterministic pricing data corresponding to a value for the assets of the order.

The system 100 can update the interface of the electronic device with status information for the order and output data of electronic trading system generated by executing the order using the ME 170, the SML 160, and the AMM 180.

The system 100 closes open orders and checks for solvency, which can also be referred to herein as a solvency check. That is, the system 100 checks that if the closure of orders resolves insolvency then the system 100 may not liquidate the client's collateral if not needed. However, the system 100 may choose to close all open orders for a position at once so that even if closing only some would be sufficient to get back to solvency then the system 100 closes all orders to avoid determining which orders to close first. The system 100 may not try to determine if some portion of the position debt can be paid off and instead the system 100 can pay off all debt for that position on one action.

The hybrid order book integrates liquidity provided by an AMM 180 with liquidity provided by a central limit order book into a common order book. The ME 170 executes the order using the hybrid order book integrating liquidity provided by the AMM 180 with liquidity provided by the central limit order book into the common order book. The SML 160 for margin lending, after execution of the order, implements a solvency check to determine whether another order of a maximum size does not impact solvency of margin accounts based on liquidity available from the automated market maker of the hybrid order of the electronic trading system. Upon the solvency check determining that the other order of the maximum size does impact the solvency of the margin accounts, the SML 160 preemptively liquidates all margin accounts impacted. The SML 160 can implement the solvency check by determining a LCP and executing the solvency check against only the LCP. The SML 160 implements the solvency check by querying the AMM 180 for deterministic pricing data corresponding to a value for the one or more assets relating to the order. In some embodiments, the trading commands for the order indicate one or more digital assets, such as cryptocurrency. In some embodiments, the order comprises a trading order price and a trading order size. In some embodiments, the electronic communication bus is an interprocess communication bus.

The electronic trading system manages a trading exchange for different types of assets such as digital assets. The system 100 has a hybrid order book with SML 160, ME 170, and an AMM 180.

The SML 160 provides for deterministic margin/model lending by obtaining deterministic pricing from AMM 180. The SML 160 provides margin lending for orders. The SML 160 can implement margin lending using a liquidity pool. The SML 160 presents multiple pools as a single source of liquidity extending to the multiple pools. The SML 160 uses AMM 180 to determine how much liquidity is provided by the hybrid order book (e.g. AMM 180 integrated with a central limit order book). The SML 160 uses AMM 180 for pricing digital assets relating to the order to determine when one or more margin accounts are solvent. The SML 160 implements a solvency check for orders received by system 100. The SML 160 uses AMM 180 for its pricing process (e.g. algorithm/formula) to determine liquidity at different price levels. AMM 180 integrates with a central limit order book. AMM 180 also implements a dislocation spread, as described herein. The SML 160 queries AMM 180 and checks its debt pool (which is part of SML 160).

The ME 170 executes orders by checking with the AMM 180 to see if the system 100 has liquidity, and its closed limit order book. The ME 170 executes multiple orders and multiple price levels against its order book and also checks with the SML 160 (and the AMM 180) at each price level to see if the system 100 can contribute to the order (via margin lending, for example). The ME 170 iterates through all the orders to see if the AMM 180 can offer additional liquidity.

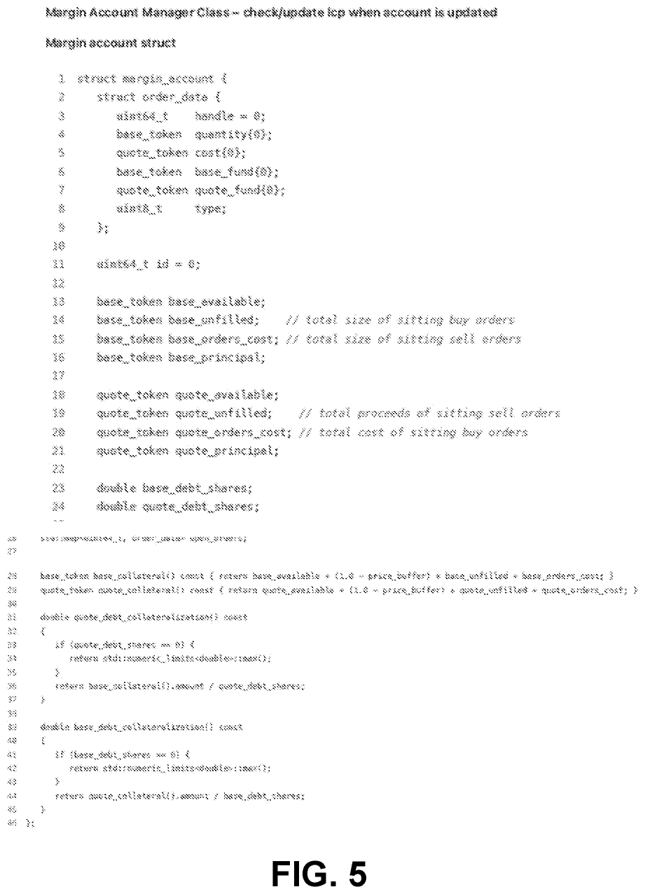

FIG. 5 shows an example diagram of a margin account manager class and margin account data structure.

The system 100 can have different functions for accounts and orders. For example, an account might not have both base and quote debt at the same time.

The system 100 can process different types of orders and requests.

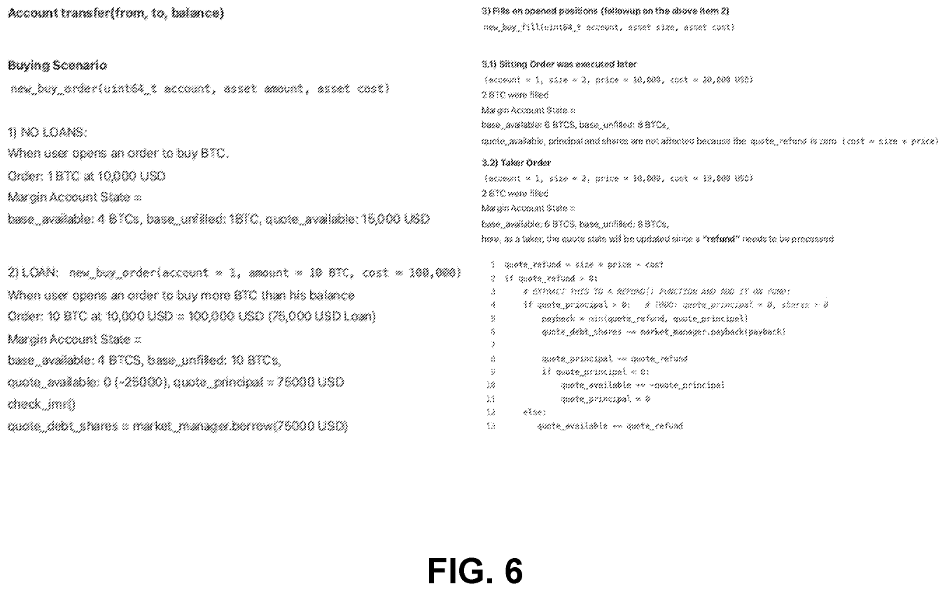

FIG. 6 shows an example account transfer order that can be processed by system 100. The system 100 can receive a new buy order for cryptocurrency.

As another example, the system 100 can receive a cancel order. The system 100 can also have functions to return the order book value and the order book base. As a further example, the system 100 can have a payback function, a borrow function, interest calculation function, liquidation function, solvency check, and so on.

The system 100 can have an MMS manager and an event manager. The MMS manager can process withdraw orders, for example.

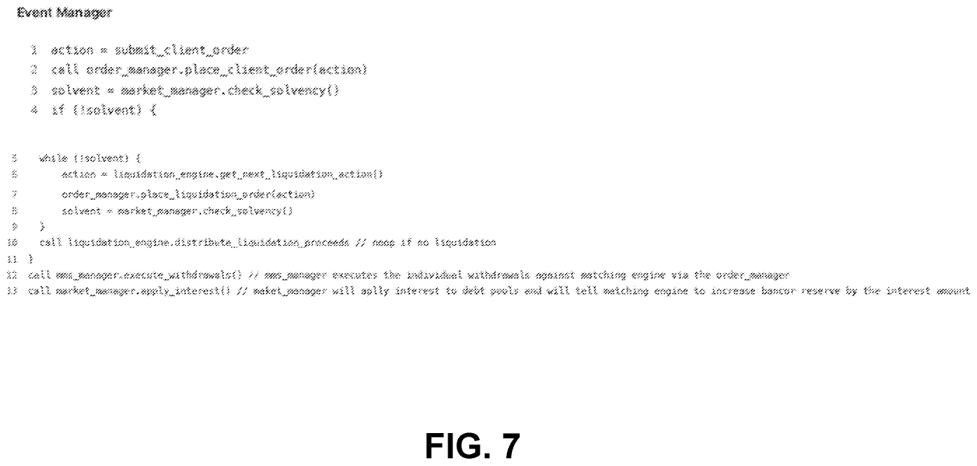

FIG. 7 shows an example function for an event manager.

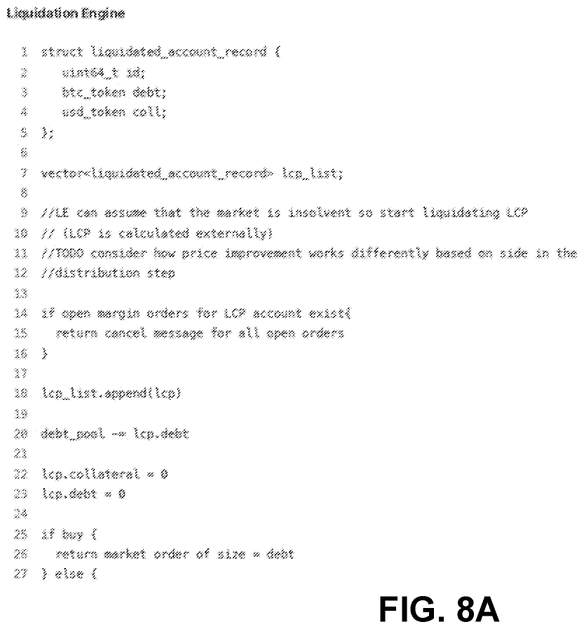

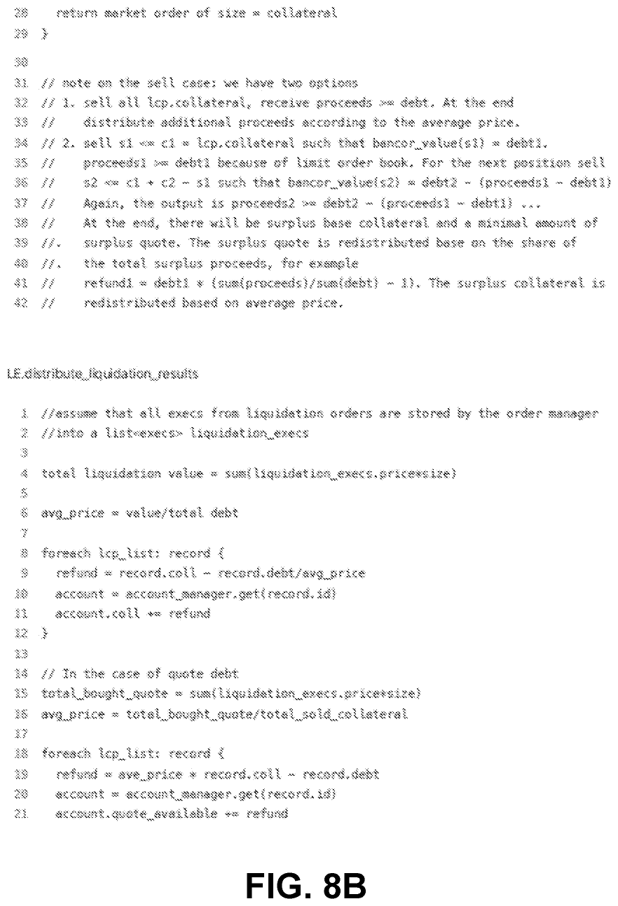

FIGS. 8A and 8B shows an example function for a liquidation engine.

An order manager can implement different functions to manage orders for system 100. For example, if the account can be updated then the order manager can update a margin account with the open order. The order manager can place orders and consume results of the orders. The order manager can update margin accounts balances based on the results (order update events or execution events). The order manager can filter for margin executions. The order manager can update (margin) accounts with execution results. If the placed order is a liquidation order, the order manager can pass the executions to the liquidation exec store.

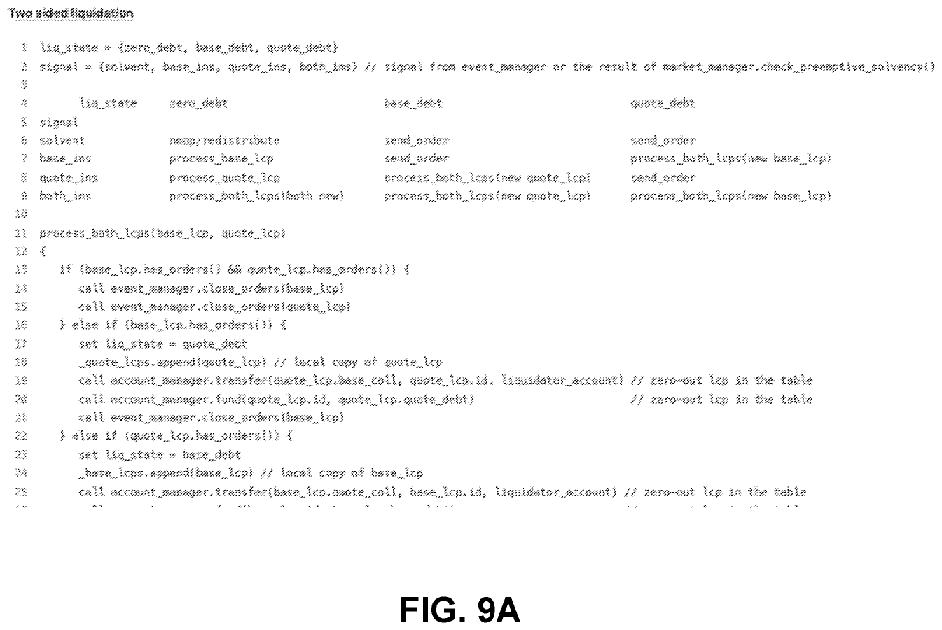

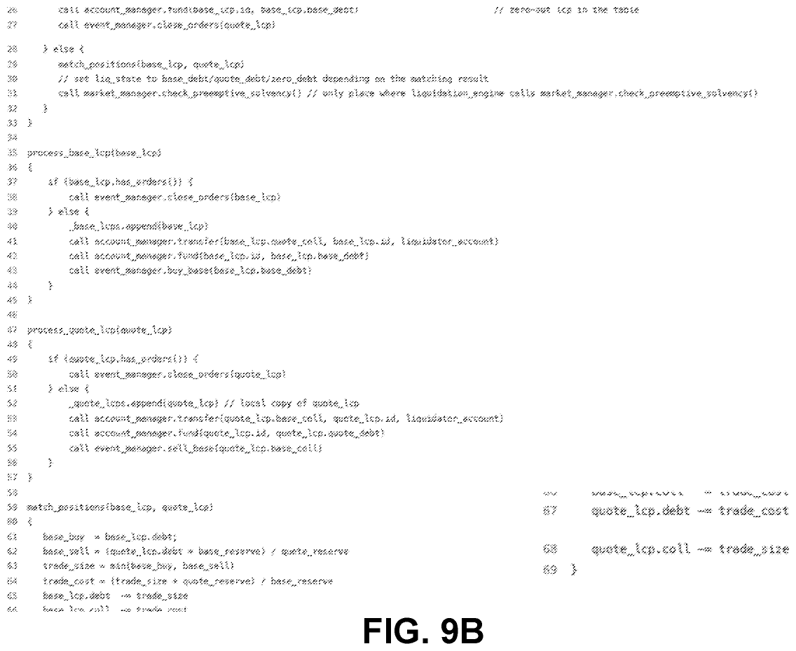

FIGS. 9A and 9B shows an example function for a two-sided liquidation.

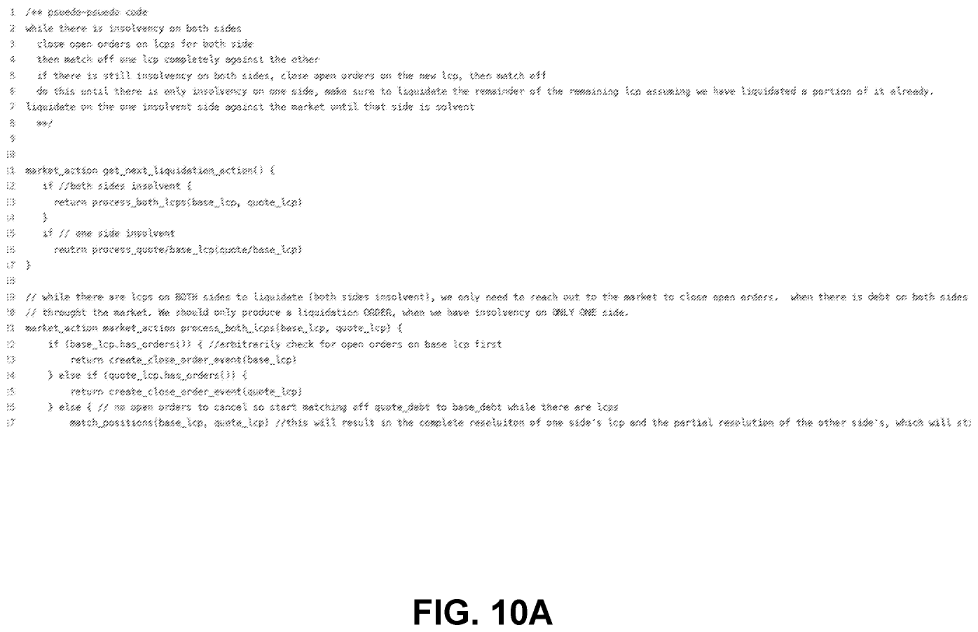

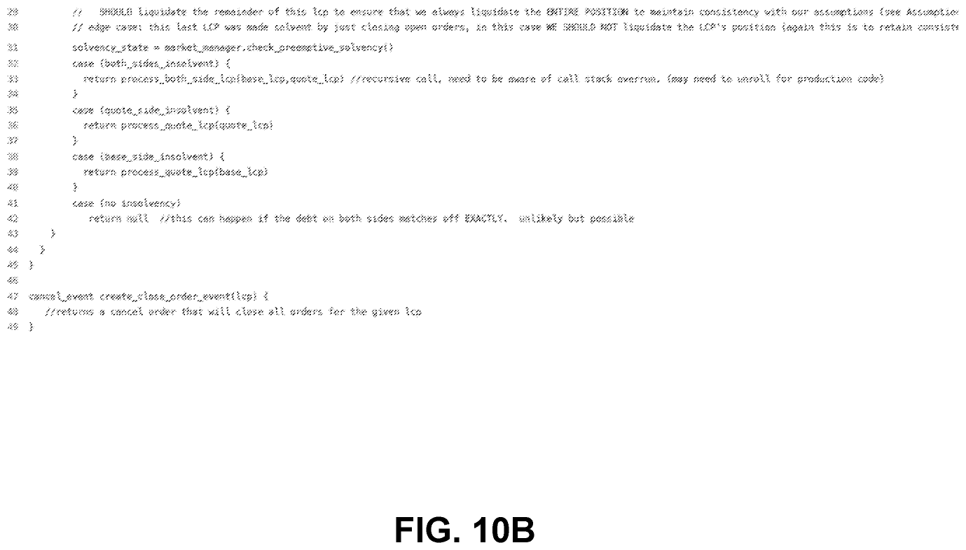

FIGS. 10A and 10B shows example code for iterating through Least Collateralized Position (LCPs) on both sides, only returning close order events to be processed on the market. As long as there are LCPs that need to be liquidated on both sides, there should be debt on both sides to match off. The system 100 can create a liquidation order when one side is solvent so there is no debt on both sides to match off. The example code assumes that the effect of all matching, closing of orders, execution of liquidation orders is reflected in the next pre-emptive solvency check call. This may be the case for close order and liquidation order execution since they are executed against the market and that should update appropriate balances.

The system 100 has SML 160. In some example, SML 160 can have different requirements. For example, requirements for SML 160 can include: the base and quote debts can always be solvent; solvency condition can be checked in constant time, margin positions can be liquidated at the same time to get the same liquidation price, a user cannot generally cause liquidation by solely borrowing, unless the LCP is not sufficiently collateralized.

Bancor protocol can refer to an automated order book that allows asserts or tokens to be programmatically exchangeable. Infinitesimal bancor price p can be defined as p=q/b, with base reserve b, quote reserve q. The MMS supply can represent ‘shares’ in the two reserves. Buying from bancor order book subtracts from b and adds to q, thus increasing p. Selling to bancor order book adds to b and subtracts from q, thus decreasing p. Further, b*q=constant upon trading. Bancor is an example of an AMM. The system 100 can use Bancor for guaranteed pricing for different margin positions. Distributions of prices vary so the AMM allows for improved pricing which can be executed efficiently by processor to rapidly evaluate LCP.

$$Buying amount db from bancor = > cost = dq = db * q / ( b - db )$$

$$Selling amount db tp bancor = > proceeds = dq = db * q / ( b + db )$$

Note that dq≠p*db because of slippage.

Bancor order book can be formulated as an order book with a continuum of sitting orders. Users' unfilled orders sit on top of bancor order book. Taker orders are filled against bancor order book and sitting orders depend on the price.

An initial supply of MMS tokens (S0) can be issued when the reserves are initialized. A user can buy MMS tokens by providing both base and quote currencies. Buying MMS does not result in changing the bancor order book price. A user can sell MMS, and the order can be filled gradually over a week in order to allow orderly liquidations if needed.

The system 100 can involve debt pools. There can be base and quote debt pools. A borrower holds shares in the corresponding debt pool. The following can be used to define a debt pool:

$$debt ( i ) = value ( shares ( i ) ) = shares ( i ) * debt\_pool \_balance / sum ( shares )$$

Interest can be applied to debt_pool_balance, thus increasing the individual debt. Value of one share does not change when borrowing or paying off debt. Value of one share increases when interest is applied.

The system 100 can involve margin positions. A base position can be defined as base debt (shares) and quote collateral. A quote position can be defined as quote debt (shares) and base collateral. Debt is incurred upon order submission. LCP can be determined by debt_shares divided by collateral. Collateral includes available balance and the balance available in sitting orders. Per position can be defined as CMR=collateral/bancor_cost(debt), CMR is unitless. There can be configuration parameters IMR and MMR, where IMR is greater than MMR. On order submission, the condition can be CMR is greater than IMR. When CMR is less than MMR (but still solvent) then the user gets a margin call. Leverage can be defined as CMR/(CMR-1). For example, when CMR=1.2 then the leverage=6. As another example, when CMR=1.5 then the leverage=3. As a further example, if a user provides 0.5 BTC coll, buys 1 BTC@50K then debt=50K and collateral=1.5 BTC, CMR=1.5 as long as the price stays 50K.

According to embodiments described herein, the system 100 has SML 160 based on the total available collateral. The SML 160 has a condition such that the total available collateral is sufficient to buy total debt from the order book.

The SML 160 can compute a conservative estimate of the total collateral by assuming all positions have the same collateralization as the LCP. In some embodiments, SML 160 can compute a solvency line for base debt is given by qc/bl=q/(b−B) where
qc=quote collateral of LCP
bl=base loan of LCP
b=base reserve
q=quote reserve
B=base debt pool balance

SML 160 can do a solvency check and liquidation after each order is submitted. For example, SML 160 can compute a max_q process as a solvency check that pre-emptively takes into account the effect of an order of the maximum allowed size, this effect is included in the values of b and q used by the system 100. The reserve values also take into account the effect of the next MMS withdraw. The debt pool value B include the interest to be applied next. The MMS withdraw and interest application are executed after the liquidation. This can determine a limit for the max order size of an order so that LCP is solvent right now but a subsequent (large) order may impact solvency. After doing a solvency check, the SML 160 can check for the maximum movement of the order to determine the maximum price movement as a solvency check.

In order to prevent users from causing the liquidation of LCP by merely borrowing (sending a sitting margin order), SML 160 can set a max debt pool size. At the solvency line, base debt pool size B can be B approximately b/lcp_lvrg. If CMR is less than MMR, Bmax=b/lcp_lvrg. If CMR is greater than MMR, Bmax=b/mmr_lvrg, mmr_lvrg=MMR/(MMR−1).

The system 100 uses SML 160 for liquidation. If the base debt is insolvent then debt can be bought from market using collateral, and liquidated positions are refunded the surplus collateral.

If the quote debt is insolvent then the system 100 can sell collateral in the market to cover the debt, and liquidated positions are refunded the surplus proceeds. If base and quote debts are insolvent then match opposite liquidated positions and the system 100 can go to the market. Open orders of a liquidated position can be closed first (may become solvent).

SML 160 can implement the solvency check against bancor order book only, and does not include sitting orders. The check is done in constant time with stricter solvency condition. Liquidation is done against the hybrid order book (e.g. bancor order book and sitting orders). The distribution of surplus collateral or proceeds can be done after all insolvent positions are liquidated.

Accordingly, system 100 uses SML 160 to implement margin trading which is a way of trading assets using borrowed funds. Margin trading may require an initial investment from the trader (“margin deposit”), and the initial investment and the traded asset act as collateral for the margin loan. Margin trading can provide leverage as a way of magnifying returns. Margin trading can be useful for short-selling which involves selling borrowed assets, betting on their decline. Margin trading involves transferring some assets into margin account (“Margin Equity”). Margin long refers to borrowing funds and buying an asset with them. Margin short refers to borrowing assets and selling them. A margin long position means that the user has borrowed some money to buy the asset. The user would make a profit if the price of the asset increases. A margin short position means that the user has borrowed the asset and sold that asset in the market. The user will profit if the price of the asset decreases.

Margin trading may involve system 100 computing leverage ratios. For example, leverage ratio can involve a formula: Assets/Equity (Long positions); Loan/Equity (Short positions). This can measures how risky a margin account is. Higher leverage ratio means higher risk. Equity involves Asset minus. Debt. A leverage ratio can be expressed as a Margin Rate=1/Leverage. Margin long can be computed as Equity/Assets; Short: Equity/Loan. Lower leverage ratio means higher risk.

Margin trading may involve system 100 computing collateralization ratios, or Collateral-to-Debt ratio. The formula can Collateral/Debt. This can measure how risky a margin account is. Lower collateralization ratio means higher risk. Example values are 1.5, 1.2, 1.1. A collateralization ratio greater than 1.0 is a check for position solvency.

System 100 can implement SML 160 to provide margin trading using liquidity pools to provide a source of lending and asset liquidity. Traditional exchanges rely on statistical estimates with no guarantees. Cascading margin liquidations can cause losses for lenders and traders. This can also create unnecessary liquidations due to short-term liquidity crunches. System 100 uses SML 160 to ensure adequate margin cover and increases overall market performance (no need for statistical estimates). This can build borrower confidence, thus increasing margin activity. SML 160 relies on the Liquidity Pool guaranteed (formula-driven) liquidity. SML 160 calculates exact points when margin positions are to be liquidated.

To be able to liquidate, at all times, all the loans without having a default on any account, SML 160 can keep track of the Sum of Loans and the Least Collateralized Position (LCP). SML 160 scales the sum of all loans by the LCP collateralization ratio, to give a Lower Bound Sum of Assets. The system is safe if the Cost of Liquidating all loans is less than the Lower Bound Sum of Assets. Cost to liquidate all loans can be calculated against the Liquidity Pool only, for example (Liquidity Pool or LP Size leads to more lending). Position liquidation can be executed against the Hybrid Order Book (BLP depth+Limit Order depth).

SML 160 implements pre-emptive liquidation. Non-pre-emptive SML can liquidate insolvent positions before executing a new order. When the exchange receives an order, it simulates executing the order. Then the exchange checks the solvency of all the loans (after simulated order execution). When the exchange gets an order that would lead to an insolvency, the exchange will first liquidate positions until it can execute that order without causing an insolvency. The non-pre-emptive SML may provide a user experience that not ideal for orders that trigger liquidations. The trader sees a certain amount of liquidity on the hybrid order book. Trader sends an order that triggers liquidation. Trader's actual fill can be different from what they saw on screen. This happens because liquidation happens before the order is executed. SML 160 can implement pre-emptive liquidation SML to addresses the user experience issue. This can ensure that the exchange does not have to liquidate positions before executing an order. The pre-emptive execution by SML 160 can balance the trader's need for predictability with lenders' margin safety needs. This can involve pre-emptively liquidating margin positions which are within one Max Order Quantity of being liquidated. Any order coming to the exchange is less than Maximum Order Quantity (“maxQ”) which can be set at 100 BTC for BTC/USD pair, comparable to other major exchanges. After every trade, system 100 can implement an SML liquidation check, assuming that an order of maxQ size was executed. If exchange is insolvent, system 100 can liquidate margin positions until it is able to execute an order of maxQ size. The check is performed for both buy and sell trade sides. This can result in same margin safety as the non-pre-emptive SML, but with deterministic execution within maxQ.

The system 100 can assess the liquidation risk of different trader positions. Risk groups can be calculated for individual positions and communicated to an interface. The closer current price to the position's (dynamically updated) liquidation price, the higher the risk of liquidation. There can be different factors affecting the position's distance to liquidation price or risk of position's liquidation. A factor can be the position's own individual leverage (e.g. higher leverage can lead to higher liquidation risk). Another factor can be the interaction between the size of the outstanding Loan Balances, and Liquidity Pool size. Relevant Loan Balances can be on the same side as the position (e.g., long BTC=>USD Loan Balances). The higher the Loan Balance, the higher the liquidation risk. The higher the BLP size, the lower the liquidation risk. Accordingly, SML 160 can avoid liquidation cascades.

System 100 can support post-liquidation accounting. A goal of this accounting can be to give all the margin positions that are liquidated in the same cycle the same average price.

Liquidating multiple base debt positions involves buying total debt either from the market or from quote debt positions. This can result in multiple buy trades with different prices which include the trades against the opposite positions executed at the bancor infinitesimal price (no slippage). The liquidation price is the average price of all the trades.

$$price = sum ( buy\_trade . price * buy\_trade . quantity + buy\_trade . quote\_fee ) / sum ( buy\_trade . quantity )$$

System 100 can also liquidate multiple quote positions. System 100 can calculate the amount of base collateral that needs to be sold such that the generated proceeds are equal to the quote debt. First, collateral is sold to the opposite base LCPs, and then to the market. System 100 can accumulate the remaining base collateral of all positions into the tot_surplus_coll sum. The amount sold can be calculated based on the bancor order book price, and the actual execution can occur against both bancor order book and the limit order book. The collateral sold to the market might generate more proceeds than the debt. The surplus is saved by system 100 in the tot_surplus_proceeds variable.

After liquidating all positions, system 100 can compute and store cumulative quantities:

$$\begin{matrix}tot\_surplus \_coll = tot\_collected \_coll ‐ tot\_sold \_coll \\ tot\_sold \_coll = sum ( sell\_trade . size + sell\_trade . base\_fee ) \\ tot\_quote \_proceeds = sum ( sell\_trade . size * sell\_trade . price ) \\ tot\_liquidated \_debt \\ price = tot\_quote \_proceeds / tot\_sold \_coll - average price of all resulting sell trades \\ tot\_surplus \_proceeds = tot\_quote \_proceeds - tot\_liquidated \_debt \\ tot\_surplus \_value = tot\_surplus \_proceeds + price * tot\_surplus \_coll - total value in quote\end{matrix}$$

System 100 can compute total surplus value as units of the surplus collateral and surplus proceeds that will be distributed among liquidated positions. After liquidating all positions, we have these cumulative quantities:

$$\begin{matrix}tot\_surplus \_coll = tot\_collected \_coll ‐ tot\_sold \_co11 \\ tot\_sold \_coll = sum ( sell\_trade . size + sell\_trade . base\_fee ) \\ tot\_quote \_proceeds = sum ( sell\_trade . size * sell\_trade . price ) \\ tot\_liquidated \_debt \\ price = tot\_quote \_proceeds / tot\_sold \_coll ‐ average price of all resulting sell trades \\ tot\_surplus \_proceeds = tot\_quote \_proceeds ‐ tot\_liquidated \_debt \\ tot\_surplus \_values = tot\_surplus \_proceeds + price * tot\_surplus \_coll\end{matrix}$$

System 100 can compute total value in quote units of the surplus collateral and surplus proceeds that will be distributed among liquidated positions.

For each liquidated position, the system 100 can compute:

$$\begin{matrix}init\_debt ‐ quote \\ init\_coll ‐ base \\ proceeds = price * init\_coll ‐ proceeds if init\_coll were sold at price \\ refund\_value = proceeds ‐ init\_debt \\ quote\_refund = ( refund\_value * tot\_surplus \_proceeds ) / tot\_surplus \_value \\ base\_refund = ( refund\_value * tot\_surplus \_coll ) / tot\_surplus \_value .\end{matrix}$$

System 100 can verify that sum (refund_value)=tot_surplus_value. If all quote debt positions are liquidated against opposite positions, the calculations give quote_refund=0. Whereas if all the positions are liquidated against the market, the calculations result in base_refund=0, as expected.

Effectively, the liquidation price for each base LCP i is

$$price\_i = ( init\_debt + quote\_refund ) / ( init\_coll ‐ base\_refund )$$

$$System 100 can verify that price\_i = price = tot\_quote \_proceeds / tot\_sold \_coll for all liquidated quote LCPs .$$

The Appendix attached herein shows example operations for Cordis which can be used to implement aspects of the ME 170, and other components of system.

System 100 can implement market makers such as Automated Market Maker (AMM) 180 to provide an exchange tool which offers guaranteed liquidity by using token pools. The Price is determined programmatically based on the pool balances and the size of the trade. In some embodiments, AMM 180 adjusts its prices only after somebody trades with it. The system 100 has a hybrid order book with the AMM 180 marking making service.

A challenge for Internal Market Makers is “Impermanent Loss” (IL). An example source of IL is volatility in the exchange rate between the two assets held in the liquidity pool.

System 100 can implement price dislocation computations and fees. Price dislocation fee is a dynamic fee added to the fixed spread in the BLP (liquidity pool) pricing when the spot price has moved sufficiently far from the historic average price. System 100 can establish a process for selecting the Dislocation fee parameter values. System 100 can examine key sensitivities and trade-offs involved in parameter value selection.

System 100 can implement dislocation fee parameter selection by finding balance between BLP return and Probability of charging high fees. System 100 can maximize Returns while keeping Probability of High fees below acceptable limits. System 100 can filter sort results by BLP Return compared to Probability of charging high fees. The dislocation fee is a dynamic fee added to the fixed spread in the BLP pricing when the spot price has moved sufficiently far from the historic average price. The spread increases non-linearly the further the spot price moves from the historic average. System 100 can implement an objective data-driven process for selecting parameter values. System 100 can implement BLP arb simulation, summary statistics (BLP returns, probability of high fees), filtering. System 100 can implement Arb simulation with fixed external fees and Spread, and floating Dislocation Fee parameters. System 100 can estimate Target Variable (BLP Return, Mean Fee) sensitivities to key input parameters. System 100 can implement filtering of parameter value combinations based on pre-defined optimization criteria. For example, filtering involve resulting input parameter combinations being sorted and filtered by “Risk Adjusted Return”.

The following is an illustrative example:
Filter positive Risk Adjusted Return combinations for below-average probability of high fees
   Highest RAR combination (EMA=15 min, Max_Disloc_Pct=5%, CurveShape=1.5) has above-average Prob (high fee)=5.53%
   For lowest Prob (high fee)=1.06%, highest RAR combo is EMA=15 min, Max_Disloc_Pct=16%, CurveShape=1
   Highest RAR criterion favors shorter EMA periods, filtering for lower prob (high fee) allows for higher EME period values
   Accepting lower BLP return allows EMA=120 min (Max Pct=18%, CurveShape=1) and EMA=60 min (Max Pct=19%, CurveShape=1)

System 100 provides a data-driven process for selecting dislocation parameter values.

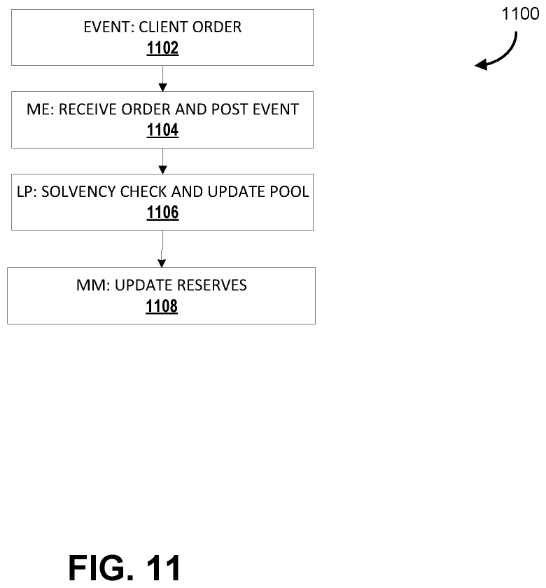

FIG. 11 shows an example method 1100 for the trading platform. At 1102, method involves event manager 330 placing client orders and transmitting commands to order manager 310. At 1104, the matching engine (ME) 170 receives the order (e.g. insert, amend, close) from the order manager 310. The ME 170 posts inline action to market events on Rodeos. At 1108, the order manager 310 transits commands to the market manager 340 to update reserves, which in turn sends commands to the ME 170 to add interest to the order book reserves. The order manager 310 transits commands to the account manager 360 to update on trades, new orders, and closed orders. At 1106, the market manager 340 and liquidation engine 350 exchange messages for the total withdrawal amount for solvency checks and pre-liquidation data to update the debt pool (e.g. on order transfer, fill, cancel).

The method involves executing the following steps.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

One should appreciate that the systems and methods described herein may provide better memory usage, improved processing, improved bandwidth usage.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

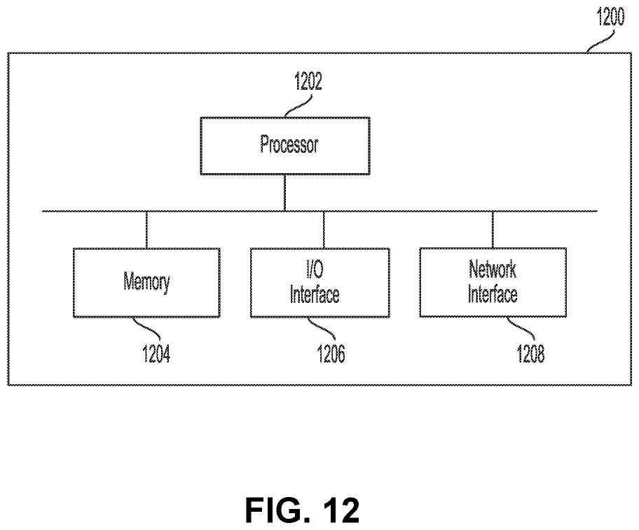

FIG. 12 is a schematic diagram of an electronic device 1200 for a trading platform, e.g. to transmit order commands and display improved visualizations of trading data. As depicted, computing device 1200 includes at least one processor 1202, memory 1204, at least one I/O interface 1206, and at least one network interface 1208.

Each processor 1202 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 1204 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1206 enables computing device 1200 to interconnect with one or more input devices, such as a keyboard, mouse, camera, touch screen and a microphone, or with one or more output devices such as a display screen and a speaker.

Each network interface 1208 enables computing device 1200 to communicate with other components, to exchange data with other components, to access and connect to network resources, to serve applications, and perform other computing applications by connecting to a network (or multiple networks) capable of carrying data.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps

As can be understood, the examples described above and illustrated are intended to be exemplary only.

What is claimed is:

1. A method for facilitating electronic trading with an electronic trading system and interfaces of electronic devices, the method comprising:
receiving, by at least one processor of a computing device of an electronic trading system, from an interface of an electronic device, trading commands for an order, the electronic trading system having a hybrid order book integrating liquidity provided by an automated market maker with liquidity provided by a central limit order book into a common order book;
communicating the trading commands for the order within the electronic trading system using an electronic communication bus of the electronic trading system;
executing the order using a matching engine and the hybrid order book integrating liquidity provided by the automated market maker with liquidity provided by the central limit order book into the common order book;
after execution of the order, implementing a solvency check, using a safe margin lending service for margin lending, to determine whether another order of a maximum size does not impact solvency of margin accounts based on liquidity available from the automated market maker of the hybrid order of the electronic trading system, wherein, upon the solvency check determining that the other order of the maximum size does impact the solvency of the margin accounts, preemptively liquidating all margin accounts impacted;
wherein the solvency check involves, by the safe margin lending service, determining a least collateralized position (LCP) and executing the solvency check against only the LCP;
wherein the solvency check involves, by the safe margin lending service, querying the automated market maker for deterministic pricing data corresponding to a value for one or more assets relating to the order; and
updating the interface of the electronic device with status information for the order and output data of electronic trading system generated by executing the order using the matching engine, the hybrid order book, the safe margin lending service, and the automated market maker service.

2. The method of claim 1 wherein updating the interface comprises generating and displaying visual elements indicating the liquidity provided by the automated market maker and overall liquidity provided by the hybrid order book.

3. The method of claim 1 wherein the trading commands for the order indicate one or more digital assets.

4. The method of claim 1 wherein the order comprises a trading order price and a trading order size.

5. The method of claim 1 wherein the interface of the electronic device is a mobile interface, web interface, or an application programming interface.

6. The method of claim 1 wherein the electronic communication bus is an interprocess communication bus.

7. The method of claim 1 further comprising:
generating a trading event corresponding to the trading commands for a client order request using an event manager application; and
transmitting the trading event to the electronic communication bus of the electronic trading system.

8. The method of claim 6 further comprising:
routing a trading event via the electronic communication bus to an order manager application of the electronic trading system to validate a client order request;
transmitting commands from the order manager application to an account manager application to process the trading event using a margin account and a liquidation engine of a safe margin lending application; and
transmitting commands from the account manager application to a market manager to update a debt pool.

9. A non-transitory machine readable medium having stored thereon a plurality of instructions that, when executed by at least one computing device, cause the at least one computing device to perform a method comprising:
receiving, by at least one processor of a computing device of an electronic trading system, from an interface of an electronic device, trading commands for an order, the electronic trading system having a hybrid order book integrating liquidity provided by an automated market maker with liquidity provided by a central limit order book into a common order book;
communicating the trading commands for the order within the electronic trading system using an electronic communication bus of the electronic trading system;
executing the order using a matching engine and the hybrid order book integrating liquidity provided by the automated market maker with liquidity provided by the central limit order book into the common order book;
after execution of the order, implementing a solvency check, using a safe margin lending service for margin lending, to determine whether another order of a maximum size does not impact solvency of margin accounts based on liquidity available from the automated market maker of the hybrid order of the electronic trading system, wherein, upon the solvency check determining that the other order of the maximum size does impact the solvency of the margin accounts, preemptively liquidating all margin accounts impacted;
wherein the solvency check involves, by the safe margin lending service, determining a least collateralized position (LCP) and executing the solvency check against only the LCP; and
wherein the solvency check involves, by the safe margin lending service, querying the automated market maker for deterministic pricing data corresponding to a value for one or more assets relating to the order.

10. The non-transitory machine readable medium to perform the method of claim 9 further comprising: updating the interface of the electronic device with status information for the order and output data of electronic trading system generated by executing the order using the matching engine, the hybrid order book, the safe margin lending service, and the automated market maker service.

11. The non-transitory machine readable medium of claim 9 wherein updating the interface comprises generating and displaying visual elements indicating the liquidity provided by the automated market maker and overall liquidity provided by the hybrid order book.

12. The non-transitory machine readable medium of claim 9 wherein the trading commands for the order indicate one or more digital assets.

13. The non-transitory machine readable medium of claim 9 wherein the order comprises a trading order price and a trading order size.

14. The non-transitory machine readable medium of claim 9 wherein the interface of the electronic device is a mobile interface, web interface, or an application programming interface.

15. An apparatus comprising:
at least one processor; and
a memory that stores instructions which, when executed by the at least one processor, directs the at least one processor to:
receive, by at least one processor of a computing device of an electronic trading system, from an interface of an electronic device, trading commands for an order, the electronic trading system having a hybrid order book integrating liquidity provided by an automated market maker with liquidity provided by a central limit order book into a common order book;
communicate the trading commands for the order within the electronic trading system using an electronic communication bus of the electronic trading system;
execute the order using a matching engine and the hybrid order book integrating liquidity provided by the automated market maker with liquidity provided by the central limit order book into the common order book;
after execution of the order, implement a solvency check, using a safe margin lending service for margin lending, to determine whether another order of a maximum size does not impact solvency of margin accounts based on liquidity available from the automated market maker of the hybrid order of the electronic trading system, wherein, upon the solvency check determining that the other order of the maximum size does impact the solvency of the margin accounts, preemptively liquidating all margin accounts impacted;
wherein the solvency check involves, by the safe margin lending service, determining a least collateralized position (LCP) and executing the solvency check against only the LCP;
wherein the solvency check involves, by the safe margin lending service, querying the automated market maker for deterministic pricing data corresponding to a value for one or more assets relating to the order; and
update the interface of the electronic device with status information for the order and output data of electronic trading system generated by executing the order using the matching engine, the hybrid order book, the safe margin lending service, and the automated market maker service.

16. The apparatus of claim 15 wherein the processor updates the interface by generating and displaying visual elements indicating the liquidity provided by the automated market maker and overall liquidity provided by the hybrid order book.

17. The apparatus of claim 15 wherein the trading commands for the order indicate one or more digital assets.

18. The apparatus of claim 15 wherein the order comprises a trading order price and a trading order size.

19. The apparatus of claim 15 wherein the interface of the electronic device is a mobile interface, web interface, or an application programming interface.

20. An electronic trading system comprising:
at least one processor of a computing device that receives, from an interface of an electronic device, trading commands for an order;
a hybrid order book integrating liquidity provided by an automated market maker with liquidity provided by a central limit order book into a common order book;
an electronic communication bus of the electronic trading system that communicates the trading commands for the order within the electronic trading system;
a matching engine that executes the order using the hybrid order book integrating liquidity provided by the automated market maker with liquidity provided by the central limit order book into the common order book;
a safe margin lending service for margin lending, that, after execution of the order, implements a solvency check, determines whether another order of a maximum size does not impact solvency of margin accounts based on liquidity available from the automated market maker of the hybrid order of the electronic trading system, wherein, upon the solvency check determining that the other order of the maximum size does impact the solvency of the margin accounts, preemptively liquidating all margin accounts impacted;
wherein the safe margin lending service implements the solvency check by determining a least collateralized position (LCP) and executing the solvency check against only the LCP; and
wherein the safe margin lending service implements the solvency check by querying the automated market maker for deterministic pricing data corresponding to a value for one or more assets relating to the order.

21. The system of claim 20 further comprising an interface of an electronic device that automatically updates with status information for the order and output data of electronic trading system generated by executing the order using the matching engine, the hybrid order book, the safe margin lending service, and the automated market maker.

22. The system of claim 21 wherein the interface comprises visual elements indicating the liquidity provided by the automated market maker and overall liquidity provided by the hybrid order book.

23. The system of claim 20 wherein the trading commands for the order indicate one or more digital assets.

24. The system of claim 20 wherein the order comprises a trading order price and a trading order size.

25. The system of claim 20 wherein the interface of the electronic device is a mobile interface, web interface, or an application programming interface.

26. The system of claim 20 wherein the electronic communication bus is an interprocess communication bus.
